(19) United States
(12) Patent Application Publication
(10) Pub. No.: US 2006/0008558 A1
(43) Pub. Date: Jan. 12, 2006

(54) Packaged peanut product and method of production

(76) Inventor: Richard R. Perdue, Taylors, SC (US)

Correspondence Address: MCNAIR LAW FIRM, PA, P.O. BOX 10827, GREENVILLE, SC, 29603-0827, US

(21) Appl. No.: 10/886,759

(22) Filed: Jul. 8, 2004

(51) Int. Cl. A23B 7/148

(52) U.S. Cl. 426/106

(57) ABSTRACT

A packaged peanut product prepared by providing fresh in-shell green peanuts, boiling the peanuts in a salted hot water bath, air cooling the peanuts after boiling to cool the peanuts to a temperature range of between 100° F. to 175° F., packaging the peanuts into a high gas barrier container when the peanuts are within the temperature range of 100° F. to 175° F., vacuum sealing the container to remove air and seal the container, submerging the container with the peanuts in a cold tap water bath until the peanuts are chilled to the temperature of the cold tap water bath, and storing the container with the peanuts in a refrigerated condition, whereby the texture and flavor of fresh green peanuts can be preserved for an extended period of time by inhibiting enzymatic activity and microbial growth in the green peanuts without artificial preservatives or extensive high temperature pasteurization and processing.

### BACKGROUND OF THE INVENTION

1) Field of the Invention

The present invention relates to the preservation and packaging of seasonal fresh green peanuts in-shell to maintain the fresh flavor and texture of the green peanuts for use in making a boiled peanut snack food during out of season months for fresh green peanuts.

2) Description of Related Art

Coinsurers claim that truly delicious boiled peanuts can only be made using freshly dug green peanuts. Only in peanut growing areas are green peanuts readily available as they are highly perishable. Additionally, green peanuts are only available three to four months of the year, further reducing their availability. Therefore, outside of peanut growing areas, boiled peanuts snack foods are prepared using dried peanuts which yields a vastly inferior eating product. Frozen green peanuts are also used but produce an inferior eating product due to changes in texture and flavor as a result of freezing.

It is important to note that there is a difference between “green” peanuts and “raw” peanuts. Basically, the level of moisture inside the peanut is the basic difference between “green” and “raw” peanuts. Green peanuts have a higher water content so they must be refrigerated upon harvesting to maintain their freshness but have a very short shelf-life. Raw peanuts are air dried to lower the water content, which makes raw peanuts less perishable, but also provides less flavor and texture when used for making a boiled peanut product.

U.S. Pat. No. 5,330,781 discloses a method for preparing boiled and seasoned peanuts having an easily splitting shell. The method is directed to providing a finished peanut product for consumption, rather than preserving the freshness of green peanuts for later boiling. The method exposes the peanuts to extensive chemical and temperature processing that eliminate the fresh flavor and texture of the peanuts, but provides a read-to-eat packaged peanut product with a long shelf-life.

U.S. Pat. No. 4,816,270 discloses a method for producing processed peanuts which results in a dried peanut product having the taste of a boiled peanut. The method involves soaking the peanuts in water, boiling the peanuts together with shredded coconut, and microwaving the boiled peanuts until dried. There is no disclosure of a method for preserving fresh green peanuts for later boiling using minimal processing to preserve the flavor and texture of the green peanuts. While dried peanuts may be used to make boiled peanut snack foods, they produce a vastly inferior eating product without the texture of flavor of sought after fresh boiled green peanuts.

U.S. Pat. No. 2,510,534 discloses a process for cooking, salting, and storing unshelled green peanuts in a salt water filled, sealed container to produce a product ready for consumption. There is no disclosure of a method for preserving the freshness of the green peanuts for later boiling.

None of the cited patents show or disclose a process for storing fresh green peanuts to maintain their freshness for later boiling to produce a high quality boiled peanut during off season months for fresh green peanuts.

Accordingly, it is an object of the present invention to provide a method of storing fresh green peanuts for later boiling during off season months for fresh green peanuts while maintaining the flavor and texture of freshly dug green peanuts.

### SUMMARY OF THE INVENTION

The above objective is accomplished according to the present invention by providing a packaged peanut product prepared according to a method which includes boiling fresh in-shell green peanuts in a hot water bath, air cooling the green peanuts after removing them from the hot water bath, packaging the green peanuts into a high gas barrier container while still warm from the hot water bath, vacuum sealing the container to remove air and seal the container in an airtight manner, submerging the container with the green peanuts in a cold tap water bath, and storing the container with the green peanuts in a refrigerated condition. As a result, the texture and flavor of fresh green peanuts can be preserved for an extended period of time by inhibiting enzymatic activity and microbial growth in the green peanuts without artificial preservatives or extensive high temperature pasteurization and processing.

Preferably, the green peanuts are rinsed in cold tap water to remove dirt and debris prior to boiling in the hot water bath.

Advantageously, the method preferably includes the step of boiling the green peanuts in the hot water bath for approximately 10 to 30 minutes, which is typically sufficient to inhibiting enzymatic activity and microbial growth in the green peanuts, although additional time may be required at higher elevations as the temperature of boiling water is lowered. In a further advantageous embodiment, the method includes adding salt to the hot water bath during boiling of the green peanuts.

In a preferred embodiment, the green peanuts are air cooling to a temperature range of between 100° F. to 175° F. Once cooled, the green peanuts are packaged into the container while within the temperature range of 100° F. to 175° F.

Preferably, the container with the green peanuts is submerged in the cold tap water bath until the green peanuts are chilled to the temperature of the cold tap water bath and then stored at a temperature of 38° F. or below.

The method also includes vacuum sealing the container using a low vacuum pressure that prevents boiling of remaining liquids in the container. High vacuum chamber methods commonly used in the food preparation industry will result in flash boiling of residual liquids on the peanuts. Accordingly, a nozzle type low vacuum system is necessary. To accommodate the nozzle type vacuum, preferably the container comprises a flexible plastic pouch having an opening for receiving the green peanuts which is sealed by crimping a metal clip around the opening following vacuumizing.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a representation of each step in the process according to the present invention; and,

FIG. 2 shows a flow chart of the method according to the present invention.

### DETAILED DESCRIPTION OF A PREFERRED EMBODIMENT

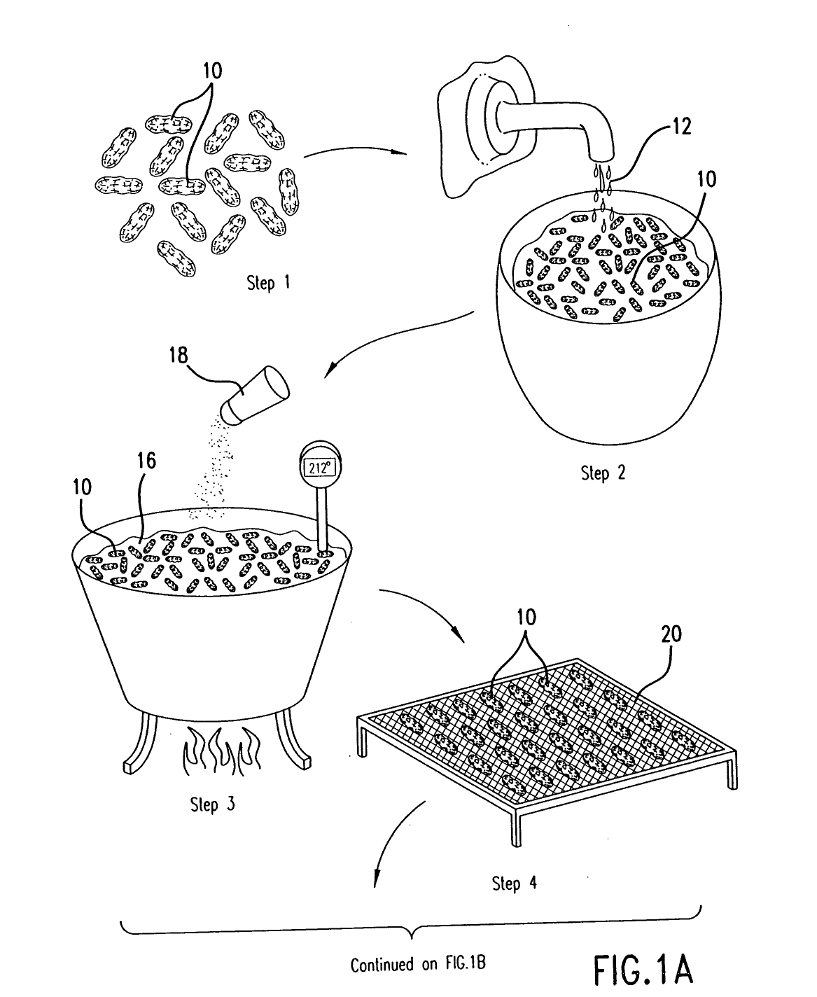

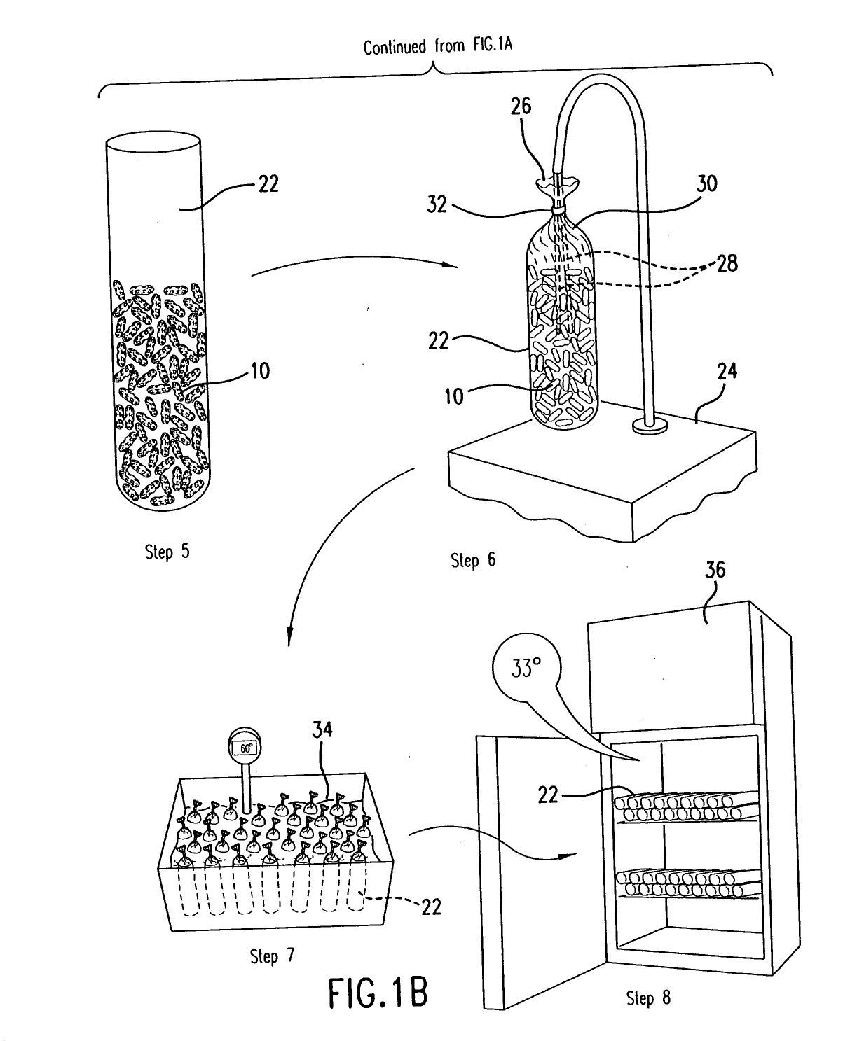

With reference to the drawings, the invention will now be described in more detail. Referring to FIG. 1, a process for preparing a packaged peanut product is depicted step-by-step. The process starts by providing freshly dug green peanuts, designated as reference number 10 in step 1. The green peanuts remain in their shells throughout the process described herein. Preferably, the green peanuts are of the “Virginia Whites” variety on which the process described herein has been successfully tested, although the process will likely work equally well with other varieties of peanuts.

After harvesting, green peanuts 10 are rinsed in cold tap water 12, shown in step 2, to remove dirt, sand, and other debris from the shells of the green peanuts. Preferably, green peanuts 10 are washed two to three times to thoroughly remove contaminants before proceeding with the next step in the processing.

In step 3, green peanuts 10, remaining in their shells, are placed into boiling water. Preferably, a large cooking vessel such as a steam jacketed kettle 14 capable of holding at least five (5) gallons of water 16 is used for providing a hot water bath in which to boil green peanuts 10. In the preferred embodiment, green peanuts 10 are vigorously boiled in the hot water bath for approximately 10 to 30 minutes to inhibit enzymatic activity which causes the peanuts to grow, as well as to inhibit microbial growth, such as yeast and vegetative bacteria cells in the green peanuts, making them stable to store for extended time periods of several months when the rest of the steps are completed. Additional boiling time may be required at higher elevations as the temperature of boiling water is lowered. In a further advantageous embodiment, the method includes adding salt 18 to the hot water bath during boiling of the green peanuts to help season, as well as preserve the peanuts during storage. The addition of salt is not, however, a necessary step and is done primarily as a matter of taste.

In step 4, green peanuts 10 are removed from the boiling water and air cooled to a temperature range of between 100° F. to 175° F. Preferably, green peanuts 10 are placed on rack 20, which allows for adequate drainage of excessive water from green peanuts 10. Ideally, the peanuts are cooled no lower than 140° F. for the best results in texture and flavor, although the process can be successfully completed at any temperature within the stated range.

Next, moving on to step 5, green peanuts 10 are packaged into a high gas barrier container 22 while still warm from the hot water bath. In the preferred embodiment, green peanuts 10 are packaged into container 22 while within the temperature range of 100° F. to 175° F., and ideally the green peanuts are not below 140° F.

Turning to step 6, container 22 is vacuum sealed to remove air and seal the container in an airtight manner. In the preferred embodiment, container 22 is vacuumized using a low vacuum pressure to prevent boiling of remaining liquids in the container. High vacuum chamber methods commonly used in the food preparation industry will result in flash boiling of residual liquids on the peanuts. Accordingly, a nozzle type low vacuum system 24 is necessary. To accommodate nozzle type low vacuum system 24, container 22 preferably comprises a flexible plastic pouch having an opening 26 for receiving green peanuts 10 and nozzle 28. Once the air is vacuumed out of container 22, the container is sealed by crimping a metal clip 32 around neck 30 following vacuumizing. This packaging method is for illustrative purposes of a preferred embodiment and the invention is not limited only to this packaging method as various other means of packaging are well known to those skilled in the art that will also work to vacuum seal the peanuts.

In step 7, container 22, having been fill with green peanuts 10 and vacuum sealed, is then submerged in a cold tap water bath 34 to cool green peanuts 10. Preferably, container 22 is submerged in cold tap water bath 34 until green peanuts 10 are chilled to the temperature of the cold tap water bath, which stabilized green peanuts 10 for storage.

In step 8, once green peanuts 10 have chilled, container 22 is stored in a refrigerated condition, designated generally as 36. In the preferred embodiment, container 22 with green peanuts 10 is stored at a temperature of 38° F. or below. To achieve the best texture and flavor, containers 22 are stored in a refrigerated unfrozen condition and can be stored for a period of several months. However, acceptable flavor and texture can still be achieved if the containers are stored in a frozen condition, which extends the storage period substantially.

As a result, the texture and flavor of fresh green peanuts can be preserved for an extended period of time by inhibiting enzymatic activity and microbial growth in the green peanuts without artificial preservatives or extensive high temperature pasteurization and processing.

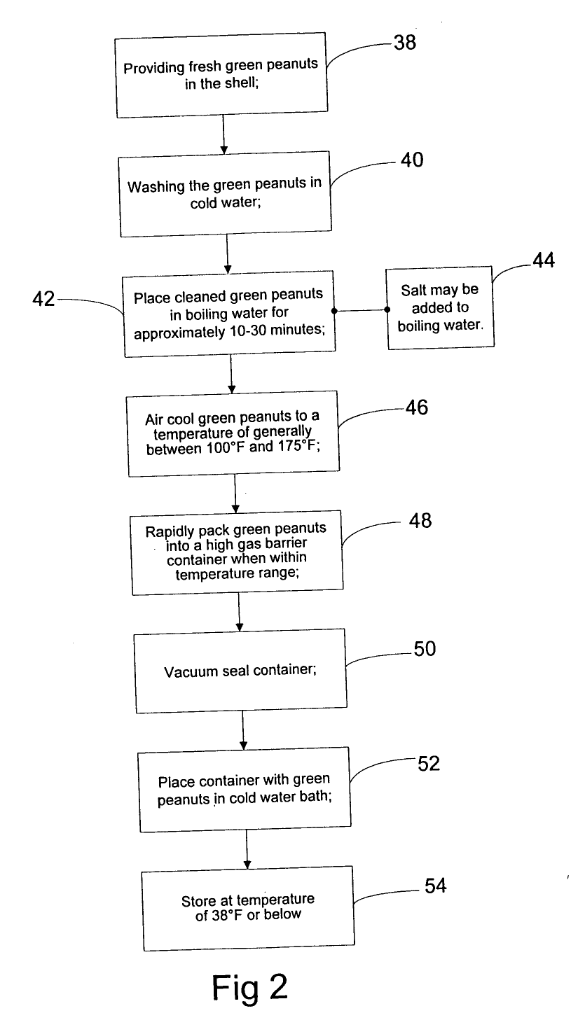

Referring to FIG. 2, a flow chart outlines the various steps in the process. In summary, the process for preparing a packaged peanut product begins by providing fresh green peanuts in the shell, 38. The green peanuts are preferably washed in cold water to remove debris, 40. The green peanuts are then boiled in water for approximately 10-30 minutes, 42. Salt may be added to the boiling water if desired for taste, 44. The green peanuts are air cooled after boiling to a temperature of range of between 100° F. to 175° F., 46. Next, the green peanuts are rapidly packaged into a high gas barrier container when within the stated temperature range, 48. The container is vacuum sealed to maintain an air tight seal, 50. The container is then placed in a cold water batch, preferably until the green peanuts are chilled to water temperature, 52. Finally, the containers with the green peanuts are stored at a temperature below 38° F., preferably in an unfrozen condition, 54.

While a preferred embodiment of the invention has been described using specific terms, such description is for illustrative purposes only, and it is to be understood that changes and variations may be made without departing from the spirit or scope of the following claims.

What is claimed is:

1. A method for preserving green peanuts comprising the steps of:
providing fresh in-shell green peanuts;
rinsing said green peanuts in cold tap water to remove dirt and debris;
boiling said green peanuts in a salted hot water bath;
air cooling said green peanuts after removing them from said hot water bath to cool said green peanuts to a temperature range of between 100° F. to 175° F.;
packaging said green peanuts into a high gas barrier container when said green peanuts are within said temperature range of 100° F. to 175° F.;
vacuum sealing said container to remove air and seal said container in an airtight manner;
submerging said container with said green peanuts in a cold tap water bath until said green peanuts are chilled to the temperature of said cold tap water bath; and,
storing said container with said green peanuts in a refrigerated condition;
whereby the texture and flavor of fresh green peanuts can be preserved for an extended period of time by inhibiting enzymatic activity and microbial growth in said green peanuts without artificial preservatives or extensive high temperature pasteurization and processing.

2. The method of claim 1 including vacuum sealing said container using a low vacuum pressure that prevents boiling of remaining liquids in said container.

3. The method of claim I wherein said container comprises a flexible plastic pouch having an opening for receiving said green peanuts which is sealed by crimping a metal clip around said opening.

4. The method of claim 1 including boiling said green peanuts in said hot water bath for approximately 10 to 30 minutes.

5. The method of claim 1 including storing said green peanuts at a temperature of 38° F. or below.

6. A packaged peanut product comprising:
fresh in-shell green peanuts subjected to boiling in a hot water bath and being air cooled to a temperature of between 100° F. to 175° F. after removal from said hot water bath;
a vacuum sealed container maintaining a high gas barrier while sealed;
said green peanuts being packaged within said container when within said temperature range 100° F. to 175° F.; and,
said container with said green peanuts being subjected to submerging in a cold tap water bath until said green peanuts are chilled to the temperature of said cold tap water bath, and stored in a refrigerated condition;
whereby the texture and flavor of fresh green peanuts are preserved for an extended period of time in said container by inhibiting enzymatic activity and microbial growth in said green peanuts without artificial preservatives or extensive high temperature pasteurization and processing.

7. The product of claim 6 wherein said green peanuts are subjected to rinsing in cold tap water to remove dirt and debris prior to being subjected to said hot water bath.

8. The product of claim 6 wherein said hot water bath includes salt for boiling said green peanuts.

9. The product of claim 6 wherein said green peanuts are subjected to boiling in said hot water bath for approximately 10 to 30 minutes.

10. The product of claim 6 wherein said container with said green peanuts is stored at a temperature of 38° F. or below.

11. A method for preserving green peanuts comprising the steps of:
boiling fresh in-shell green peanuts in a hot water bath;
air cooling said green peanuts after removing them from said hot water bath;
packaging said green peanuts into a high gas barrier container while still warm from said hot water bath;
vacuum sealing said container to remove air and seal said container in an airtight manner;
submerging said container with said green peanuts in a cold tap water bath; and,
storing said container with said green peanuts in a refrigerated condition;
whereby the texture and flavor of fresh green peanuts can be preserved for an extended period of time by inhibiting enzymatic activity and microbial growth in said green peanuts without artificial preservatives or extensive high temperature pasteurization and processing.

12. The method of claim 11 including rinsing said green peanuts in cold tap water to remove dirt and debris prior to boiling in said hot water bath.

13. The method of claim 11 including adding salt to said hot water bath during boiling of said green peanuts.

14. The method of claim 11 including air cooling said green peanuts to a temperature range of between 100° F. to 175° F.

15. The method of claim 14 including packaging said green peanuts into said container when said green peanuts are within said temperature range of 100° F. to 175° F.

16. The method of claim 11 including submerging said container with said green peanuts in said cold tap water bath until said green peanuts are chilled to the temperature of said cold tap water bath.

17. The method of claim 11 including storing said container with said green peanuts at a temperature of 38° F. or below.

18. The method of claim 11 including boiling said green peanuts in said hot water bath for approximately 10 to 30 minutes.

19. The method of claim 11 including vacuum sealing said container using a low vacuum pressure that prevents boiling of remaining liquids in said container.

20. The method of claim 11 wherein said container comprises a flexible plastic pouch having an opening for receiving said green peanuts which is sealed by crimping a metal clip around said opening following vacuumizing.
